(19) United States
(12) Patent Application Publication
(10) Pub. No.: US 2020/0014801 A1
(43) Pub. Date: Jan. 9, 2020

(54) SYSTEM AND METHOD TO ROUTE CALLS BASED UPON AGENT PERFORMANCE INDICATORS

(71) Applicant: ScoreData Corporation, Palo Alto, CA (US)

(72) Inventors: Kottappuram M. Mohiuddin, San Jose, CA (US); Ashok Bardhan, El Cerrito, CA (US); Prasanta Behera, Cupertino, CA (US); Vasudev Bhandarkar, Los Altos Hills, CA (US)

(21) Appl. No.: 16/026,864

(22) Filed: Jul. 3, 2018

(51) Int. Cl. H04M 3/523; G06Q 10/06

(52) U.S. Cl. CPC H04M 3/5233; G06Q 10/06393; G06Q 10/06398

(57) ABSTRACT

A system is provided configured to control routing of incoming customer calls to agent devices over a routing system, comprising: a processor and a non-transitory computer readable medium comprising a plurality of instructions, where the plurality of instructions comprises: instructions that, when executed, determine respective performance indicators (PIs) to associate with multiple respective agents in response to a received call; and instructions that, when executed, select a respective agent to handle the received call at least based in part upon the determined respective PIs.

### BACKGROUND

A call contact center is a centralized operation to receive or transmit a large volume of requests by telephone. In a contact center, a relatively large number of contact agents may handle telephone communication with callers. Each agent is typically assigned to a telephone connected to a central routing system, which in turn, is connected to a public-switched telephone network (PSTN) and/or to the Internet. An organization having one or more contact centers for serving customers typically provides one or more telephone numbers to the public or to their customer base, or both, that may be used to reach the service.

### SUMMARY

In one aspect, a system is configured to control routing of incoming customer calls to agent devices over a routing system. The system includes a processor and a non-transitory computer readable medium operably coupled thereto. The non-transitory computer readable medium comprising a plurality of instructions stored in association therewith that are accessible to, and executable by, the processor. The instructions include instructions that, when executed, determine respective performance indicators (PIs) to associate with respective agents in response to the received call. The PIs that are usually of most importance to contact centers include Average Handling Time (AHT), Repeat Calls, First Call Resolution (FCR), etc. The instructions include instructions that, when executed, select a respective agent to handle the received call at least based in part upon the determined respective PIs.

In another aspect, a system is configured to control routing of incoming customer calls to agent devices over a routing system. The system includes a processor and a non-transitory computer readable medium operably coupled thereto. The non-transitory computer readable medium comprising a plurality of instructions stored in association therewith that are accessible to, and executable by, the processor. Instructions are provided that, when executed, determine for each respective received call in the sequence, respective PIs to associate with respective agents. Instructions are provided that, when executed, select for each respective received call in the sequence, a respective agent to handle the respective received call at least based in part upon the respective PIs determined for the respective received call.

In another aspect, a method is provided to control routing of incoming customer calls to agent devices over a routing system. A customer call is received. Performance indicators are determined to associate with agents in response to the received call. An agent is selected to handle the received call at least based in part upon the determined PIs.

### BRIEF DESCRIPTION OF DRAWINGS

FIG. 1 is an illustrative block diagram of a contact center in accordance with some embodiments.

FIG. 2 is an illustrative graph based upon experimental call data, showing agent efficiency versus experience.

FIGS. 3A-3B are illustrative drawings of a first table (FIG. 3A) showing individual agent data and a second table (FIG. 3B) showing overall agent efficiency improvement results in accordance with some embodiments.

FIG. 4A is an illustrative block diagram of a first machine learning (ML) system to train a PHT model in accordance with some embodiments.

FIG. 4B is an illustrative block diagram of a second ML system to train an FCR model in accordance with some embodiments.

FIG. 4C is an illustrative block diagram of a third ML system to train an RCR model in accordance with some embodiments.

FIG. 5 is an illustrative first graph that prioritizes a plurality of information variables according to their influence upon average handling time (AHT).

FIG. 6A is an illustrative functional block diagram representing the PHT model of FIG. 4A used to produce an example predicted PHT for an agent for an example call.

FIG. 6B is an illustrative functional block diagram representing the FCR model of FIG. 4B used to produce an example predicted FCR for the agent for the example call.

FIG. 6C is an illustrative functional block diagram representing the RCR model of FIG. 4C used to produce an example predicted RCR for the agent for the example call.

FIG. 7 is an illustrative second graph that prioritizes a plurality of information variables according to their influence upon occurrence of repeat calls.

FIG. 8 is an illustrative functional block diagram of a call prioritization system to prioritize calls within a queue in accordance with some embodiments.

FIG. 9 is an illustrative is functional block diagram of a process to route a call to an agent in accordance with some embodiments.

FIG. 10 is an illustrative is an illustrative functional block diagram of a system to determine individual agent PHTs for individual calls in accordance with some embodiments.

FIG. 11 is an illustrative functional block diagram of an agent selection system to select an agent to handle a current call from among a set of agents having PHTs in accordance with some embodiments.

FIG. 12 is an illustrative example first prioritized agents chart identifying set of agents and associated PHTs corresponding to an example first received call in accordance with some embodiments.

FIG. 13 is an illustrative example second prioritized agent chart identifying set of agents and associated PHTs corresponding to an example second received call in accordance with some embodiments.

FIG. 14 is an illustrative example third prioritized agent chart identifying set of agents and associated PHTs corresponding to an example third received call accordance with some embodiments.

### DESCRIPTION OF EMBODIMENTS

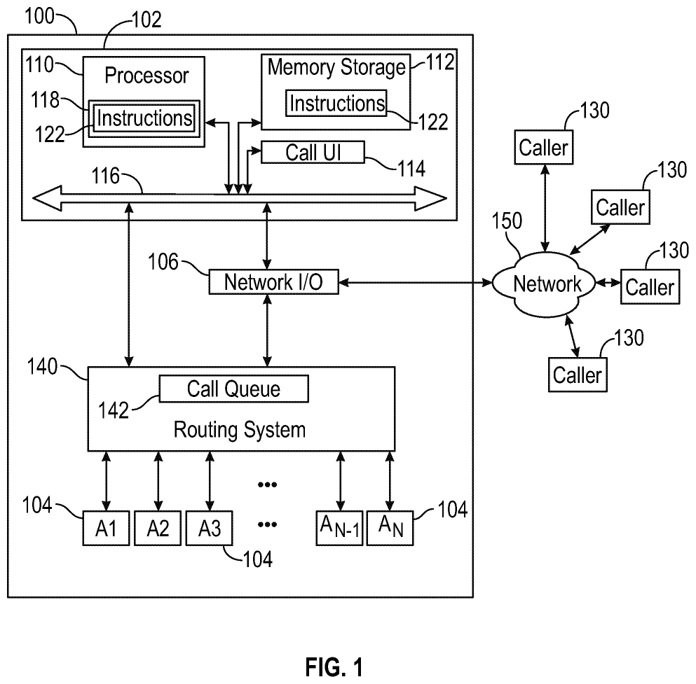

FIG. 1 is an illustrative block diagram of an embodiment of a contact center 100 in accordance with aspects of the present disclosure. The contact center 100 includes a control system 102, a plurality of agent devices 104, a network input/output (I/O) interface 106, a routing system 140 to route calls received from caller devices 130 over a communications network 150 to the agent devices 104. A caller device 130 may include a telephone or a personal computing device, for example. The communications network 150, which may include the Internet and may include the public switched telephone network (PSTN).

The control system 102 includes a processor circuit 110, non-transitory memory storage devices 112, and an interactive caller user interface (UI) 114, which can be configured to communicate with each other such as via a bus circuit 116. The processor circuit 110 may include one or more of a central processing unit (CPU), a reduced instruction set computing (RISC) processor, a complex instruction set computing (CISC) processor, a graphics processing unit (GPU), a digital signal processor (DSP), an ASIC, or radio-frequency integrated circuit (RFIC), for example. The memory storage devices 112 may include, but not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The interactive caller UI 114 may include interactive voice response (IVR), dialed number identification service (DNIS), or chat features, for example, to obtain preliminary call screening information used to route calls.

The memory storage devices 112 may store instructions 122 to configure the control system 102, the network I/O, and the routing system 140 to perform any one or more of the methodologies or functions described herein. The instructions 122 may also reside, completely or partially, within the memory 118, within the processor circuit 110 (e.g., within a cache memory device), during execution thereof by the processor circuit 110. In an example embodiment, the processor circuit 110 may read instructions 122 stored in the memory storage device 112 or the memory 118 of the processor 110 and may execute the instructions 122 to perform any one or more of the methodologies discussed herein. For example, the instructions 122 may implement modules or circuits to transform a general purpose control system 102 into a particular machine programmed to carry out particular functions in a particular manner described herein. Thus, the storage memory 112 acts as non-transitory computer readable medium to store instructions 122 that are associated with it.

The routing system 140 may be configured to receive calls over the network 150 and to route the calls, under control of the control system 102, to an agent device 104. The routing system 140 includes a queue circuit or multiple queue circuits 142 to queue calls received from a caller device 130 over the communications network 150 that are awaiting connection to an agent device 104. A call may be assigned to one of the available queues. Calls move through the queue in sequence. A call at the head of the queue is next in order to be processed. Once a call at the head of the queue is processed, a next in order call in the queue is processed, etc. Agents can be assigned to multiple queues, and they typically process calls in order starting with the calls at the head of their queue/queues. The routing system 140 may include one or more switches such as an automatic call distributor (ACD) or a Private Branch Exchange (PBX) and may include a switchless routing system such as one or more Internet Protocol (IP) routers, for example.

Agent devices 104 may include a telephone and a computer workstation that provide both computing and telephony functionality. In some embodiments, such as in an omni-channel contact center, through an agent device 104, an agent may engage in telephone conversations with a caller, respond to email inquiries, receive faxes, engage in instant message conversations, respond to website-based inquires, video chat with a customer, and otherwise participate in various customer interaction sessions across one or more channels. Further, in some embodiments, the agent devices 104 may be remotely located from the contact center 100, for example, in another city, state, or country. Alternatively, in some embodiments, an agent may include a software-based application configured to interact in some manner with a caller. An exemplary software-based application as an agent may include an online chat program designed to interpret customer inquiries and respond with pre-programmed answers.

In accordance with some embodiments, a current call may be received at the contact center 100 from a caller 134 via the network I/O 106. The processor circuit 110 may determine individual performance indicators (PIs) of operational efficiency of the contact center 100 for the current call for each of multiple agents, each associated with a different agent device 104. The processor circuit 110 causes the routing system 140 to route the current call to an agent device 104 associated with a selected agent based at least in part upon the determined PIs.

In a contact center 100, some performance indicators (PIs) of operational efficiency include Average Handling Time (AHT), and First Call Resolution (FCR) and Repeat Call Rate (RCR). AHT considers the time from when the caller gets through to an agent until they hang up. Specifically,

$$AHT = \frac{( \begin{matrix}Total Talk Time + Total Hold Time + \\ Total Wrapup Time\end{matrix} )}{Total Calls Handled} \qquad ( 1 )$$

Wrap-up Time includes any after-call work by an agent related to a particular call. A Repeat Call is any call related to a transaction such as, a purchase, insurance policy, or agreement, within a specified period, which varies with contact centers. Often the specified period may be one month or more. First Call Resolution (FCR) rate represents the percentage of calls that were resolved in the first call itself, i.e., no repeat calls for that transaction. Therefore, it is desirable to reduce repeat calls to improve FCR. Likewise, reducing AHT reduces the total amount of time spent by agents on calls and hence improves the overall efficiency of the contact center. Routing a call to an agent who can most efficiently handle a call according to a performance indicator improves the performance of the contact center 100, for example, by allowing a larger volume of calls to be processed in a given time increment, reducing the number of calls by resolving a first call from a customer without incurring a customer callback.

A call received at the contact center 100 may be routed to an agent selected based upon a determined operational efficiency PI determined for the agent such as the agent's PHT for the call, the agent's FCR for the call or the agent's Repeat Call Rate for the call, or based upon some combination thereof. Thus, for example, if a call is to be directed based upon PHT, then an individual PHT for the call may be determined for each of multiple individual agents and the call may be routed to an agent selected based upon the individual agent's determined PHT comparison with the individual PHTs determined for other agents. Alternatively, for example, if a call is to be directed based upon FCR, then an individual FCR for the call may be determined for each of multiple individual agents and the call may be routed to an agent selected based upon the individual agent's determined FCR in comparison with the individual FCRs determined for other agents.

Alternatively, for example, multiple groups of agents may be defined, based upon geography or skill or expertise or randomly, for example. Individual PIs may be determined for the individual groups. A call may be routed to a group of agents based upon the group's determined PI in comparison with the PIs determined for other groups. The agents in a selected group may handle the call according to a round-robin approach, for example.

Thus, a PI within the contact center 100 may be optimized by dynamically routing calls to the agents selected based upon the individual PIs of individual agents (or groups of agents). Agent's PIs for individual call may vary depending upon agent experience level. The more difficult calls may be routed to more experienced agents and the less difficult calls may be routed to less experienced agents, for example. Testing of a new call routing scheme may be carried out before actual implementation to determine whether the scheme improves overall call-handling performance of a contact center 100. In the past, A/B testing has been employed to evaluate the predicted benefits of a new call routing scheme, where “A” refers to the existing solution and “B” refers to the new solution. However, significant effort and potential disruption may be required to deploy a proposed new solution for A/B testing. In one aspect, the present disclosure describes a system and method to predict the benefits of an alternative call routing solution in a contact center 100 before deployment of the solution.

In accordance with some embodiments, a predictive model has been developed to produce a PIs for multiple agents of a contact center 100 on a per call basis. API for an individual agent, for example, may be obtained using an overall predictive PI model based upon individual agent parameters associated with that individual agent. More particularly, for example, a predictive model may be developed to produce PIs for agents of a call center 100 based upon call data. Call data used to train a PHT predictive model may include call data indicative of likely call duration and agent data indicative of agent call-handling efficiency. Call data used to train a FCR predictive model may include call data indicative of frequency of agents resolving a call the first time a caller calls. Call data used to train a Repeat Call Rate predictive model may include call data indicative of rate at which an agent call is followed by a repeat call.

In particular, for example, an overall predictive PHT model may be developed for the agents of a contact center 100 using training data involving a plurality of agents who handle calls at the contact center, where agent parameters are independent variables. A PHT for an individual agent, for example, may be obtained using the overall PHT model by inputting to the model individual agent parameters associated with that individual agent.

### Determining Contact Center Performance

For a PI based upon PHT, a residual value may be determined for each agent based upon a plurality of calls involving calls, by determining a difference between Actual AHT and Predicted AHT as,

Residual(Agent)=Actual AHT(Agent)−Predicted AHT(Agent) (2)

According to equation (2), agents with negative Residual values are performing better than their predicted AHTs; agents with negative Residual values may be referred to herein as “efficient agents.” Agents with positive residuals are performing worse than predicted by the model. Agents with positive Residual values may be referred to as “inefficient agents.”

An approach to improved operational efficiency of contact center 100 in accordance with some embodiments, is to route calls to an efficient agent rather than to an inefficient agent. Since efficient agents take less actual time than predicted on the average, the routed call is expected to take no more than originally predicted; for the sake of simplicity it is assumed the routed call will take the originally predicted amount of time. An estimate of improvement in overall agent call processing time at the contact center 100 can be determined by summing all the negative residual values. A further improvement in savings of agent processing time may be achieved due to the higher efficiency of the efficient agents. This efficiency, “E”, of “efficient” agents may be determined as the ratio of the sum of the residuals of the efficient operators (those with negative residuals) to the Total Predicted Handling Time of the efficient operators. The Total Actual Handling Time can be adjusted as given in equation (3) below.

An overall savings at a call center 100 may be determined by dividing the savings, THTS (Total Handling Time Savings), by the total adjusted handling time as in equation (6) and we get the efficiency improvement in overall AHT. Specifically,

$$\begin{matrix} Total Handling Time Saved , THTS = \sum Negative Residuals & ( 3 ) \\ Efficiency = \frac{ActualAHT - PredictedAHT}{PredictedAHT} & ( 4 ) \\ Adjusted Total Handling Time Saved , Adjusted THTS = THTS * ( 1 \text{-} E ) & ( 5 ) \\ AHT Efficiency Improvement = Adjusted THTS / ActuAlTotalHT & ( 6 )\end{matrix}$$

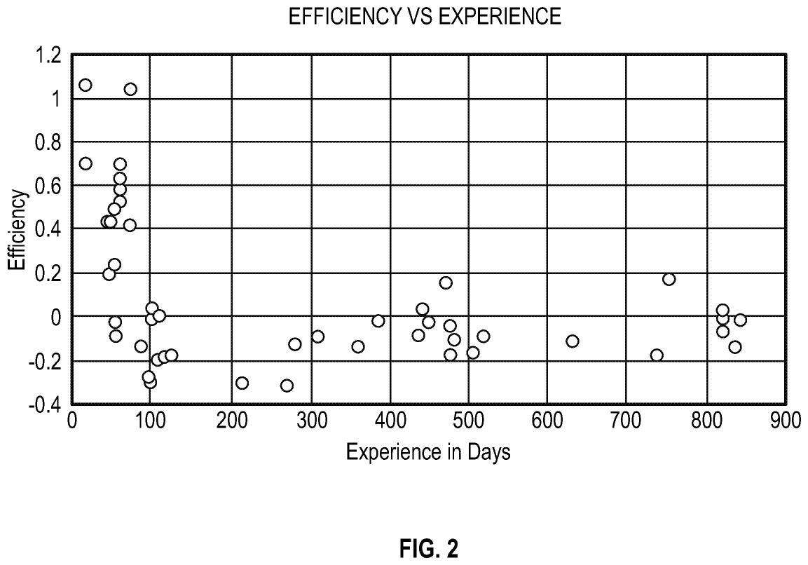

FIG. 2 is an illustrative graph based upon experimental call data, showing agent efficiency versus experience. The graph shows that agents with low efficiency (positive values for efficiency) are those who are early in their careers. However, the inventors have found that efficient agents have actual AHT less than their predicted AHT, and hence negative values for efficiency. (Note: The definition of an efficient agent is one whose actual AHT is less than predicted AHT.)

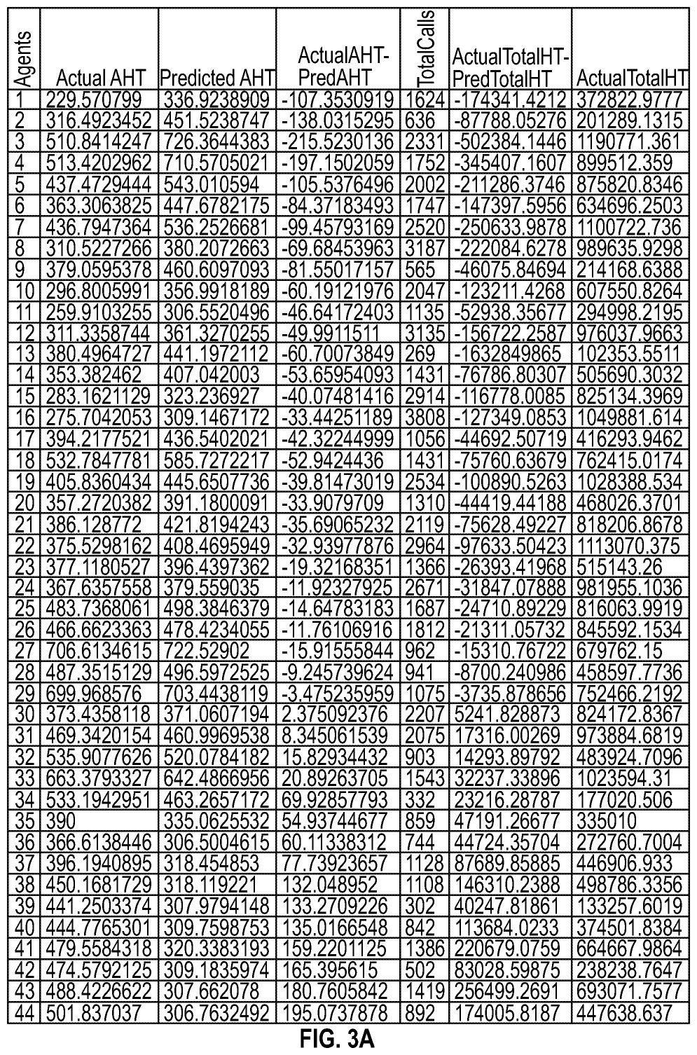

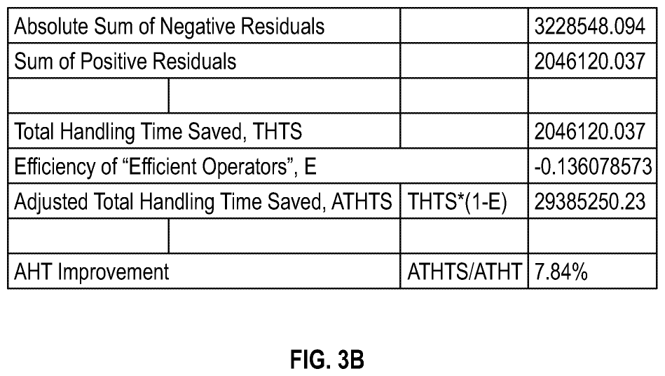

FIGS. 3A-3B are illustrative drawings of a first table (FIG. 3A) showing individual agent data and a second table (FIG. 3B) showing overall agent efficiency improvement results according to equations (1)-(5) in accordance with some embodiments. The call data in the first and second tables is representative of call data that may be obtained based upon calls to the contact center 100 during some prescribed time frame. Together, the first and second tables show an example determination of overall AHT improvement in efficiency of agent performance within the contact center 100 that may be achieved based upon results of contact center calls. Actual call information is recorded for forty-four (44) actual individual agents to determine values for Columns 2, 5, and 7. An overall predicted AHT model, which is described more fully below, is used to determine predicted AHT values of Column 3 for the forty-four (44) agents. Predicted AHT improvement that may be achieved by directing calls to more efficient agents identified based upon the actual and predicted AHT is indicated in Columns 4 and 6.

More specifically, Columns 2 and 3 provide the Actual AHT and Predicted AHT for individual agents in the call set, respectively. Column 5 provides the total number of calls handled by each agent. The Residuals, Actual TotalHandlingTime−Predicted TotalHandlingTime, determined by (Column 2−Column 3) is provided in Column 4. The Actual TotalHandlingTime, at Column 7, is given by Column 2*Column 5. The table is sorted by agent efficiency, which may be computed by (Actual TotalHandlingTime−Predicted TotalHandlingTime)/Predicted TotalHandling Time (Column 4/Column 3). In order to determine whether the proposed call routing results in overall improved contact center 100 performance, a determination is first made whether the absolute sum of negative residuals (for efficient agent 1 to efficient agent 29) is greater than the sum of the positive residuals (for inefficient agent 30 to inefficient agent 48). That is indeed the case in the experimental results example of FIGS. 3A-3B, as indicated in the second table, since 3228548.094>2046120.037. Thus, the experimental call results show that there are enough time slots for the efficient agents to handle calls originally intended for inefficient agents. Moreover, there typically is a daily limit as to the number of calls per day that may directed to an individual agent. In some embodiments, a maximum of 60 calls per day may be handled per agent. The example calls are for dates Apr. 3, 2017 to Jun. 30, 2017, for a total of about 13 weeks or 64 days. The corresponding maximum number of calls is 3,840 calls per operator. There is sufficient room in TotalCalls (Column 5) that it is not exceeded for any of the agents. So, the additional calls from inefficient agents indeed can be routed to efficient agents. The Total Handling Time Savings (THTS) indicated in the second table in FIG. 3B is the sum of positive residuals, which represents the predicted handling time savings that could be achieved based upon the experimental calls if calls had been directed to more efficient agents. By routing calls to more efficient agents, there is a predicted improvement of Efficiency(Efficient Agents)*THTS. From equation (5), the Adjusted TotalHandlingTime Savings, may be computed as 29385250.23 seconds. Expressed as a fraction of the Actual TotalHandlingTime, AHT Improvement Efficiency is 7.84% using equation (6). Thus, the experimental calls may be used to provide an estimate of the predicted savings on AHT without actually reconfiguring a contact center to perform AB testing.

### Routing of Calls to Agents

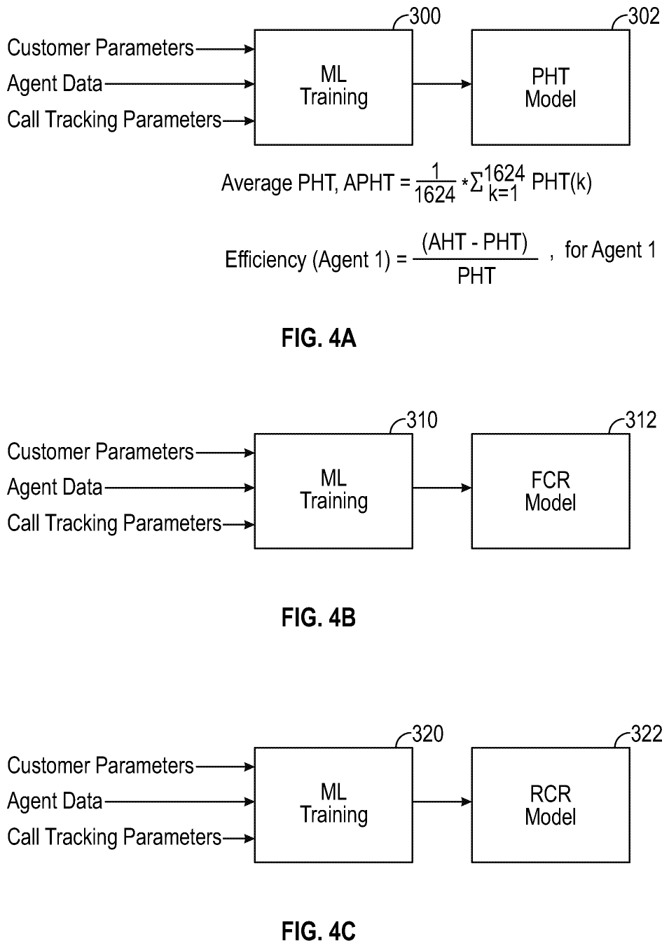

FIG. 4A is an illustrative block diagram of a first machine learning (ML) system 300 to train a PHT model 302 in accordance with some embodiments. FIG. 4B is an illustrative block diagram of a second ML system 310 to train an FCR model 312 in accordance with some embodiments. FIG. 4C is an illustrative block diagram of a third ML system 320 to train an RCR model 322 in accordance with some embodiments.

Referring to FIG. 4A, the first machine learning system 300 produces a predicted handling time (PHT) model 302 in response to training data, which includes agent data, customer data and call tracking data. The processor circuit 110 may be configured to implement the machine learning system 300 according to a machine learning method such as, gradient boosting model (GBM), logistic regression, stepwise logistic regression, ensemble of decision trees, naïve Bayes classifier, or hybrids of these, for example. The customer data and call tracking data comprise information variables derived from a plurality of training calls. Training data and test data first ML system 300 each includes call data indicative of likely duration of a call, which includes, ‘call tracking data’ and ‘customer data’. The call tracking data may include time, day, date of call, location originating the call, call-in number, product enquired about, elapsed handling time for the call, etc. The customer data may include transaction-identifying information such as, policy number for the call, gender and age of the customer, etc. The training data also includes ‘agent data’, which is indicative of agent call-handling skills. The agent data may include agent name, gender, whether new agent or not based on experience, etc. These data elements may be joined to form a master analytic table (not shown) for all the calls.

Referring to FIG. 4B, the second ML system 310 similarly produces an FCR model 312 in response to training data, which includes agent data, customer data and call tracking data. Referring to FIG. 4C, the third ML system 320 likewise produces an RCR model 322 in response to training data, which includes agent data, customer data and call tracking data. The customer data and call tracking data used by the second and third ML systems 310, 320 comprise information variables derived from a plurality of training calls.

Referring again to FIGS. 3A-3B, the call data of the first and second tables was developed based upon approximately 200,000 training data calls and approximately 100,000 test data calls. Approximately six months of training call data was collected from a contact center 100, which amounted to about 200,000 records, referred to herein as the ‘training data.’ The training data was used to train the predicted PHT model 302 of FIG. 4A. To compute estimates of the improvements in the efficiency parameters, test data also were collected from the contact center 100 for three additional months following the initial six-month period, which amounted to about 100,000 records; referred to herein as the ‘test data.’ The test data was used to determine PHTs for individual agents.

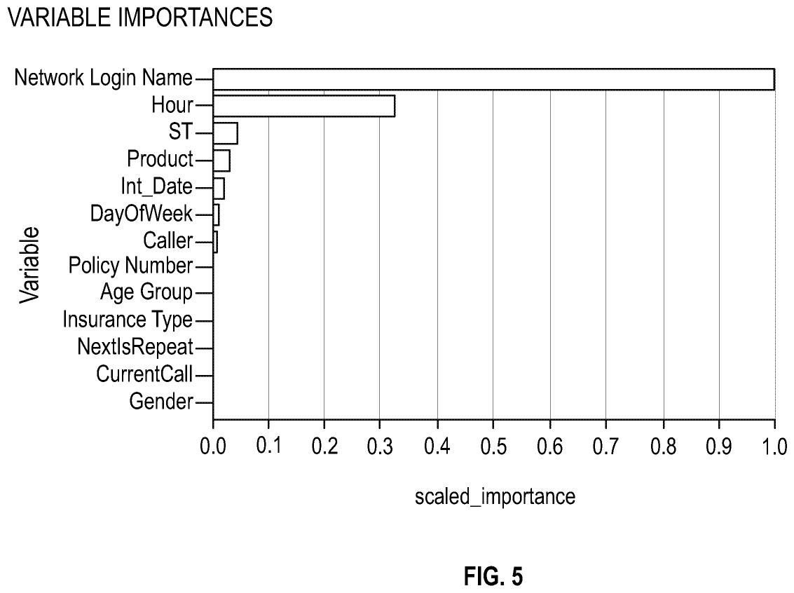

FIG. 5 is an illustrative first graph that prioritizes a plurality of information variables according to their influence upon average call handling time. The prioritization may be determined based upon training calls, for example. Network Login Name indicates the Agent. Policy No. may indicate insurance policy no. or sales contract no., for example, Int Date refers to “Integer Date” (or incremental date) measured from a starting reference date. “NextIsRep” indicates if the next call for that particular policy number is a “repeat call” (1=repeat call); note that this is used as the predicted (target) variable in repeat calls modeling only and not for AHT. “CurrentCall” indicates whether the current call is a repeat call (1=repeat call). “Calls” is used to compute the total number of calls. “Age Group,” “Gender,” etc., refer to customer's information. The first graph indicates that the agent identifier (labelled Network Login Name) is the most important parameter determining PHT, followed in significance by the time of the call, location originating the call (i.e. state), product, day of week, caller (e.g., whether owner of a policy or agent), etc. Other remaining parameters are even less significant. Since the agent is the only variable under the control of the call-routing system 140, this outcome can be exploited in reducing AHT by routing certain calls to more efficient agents.

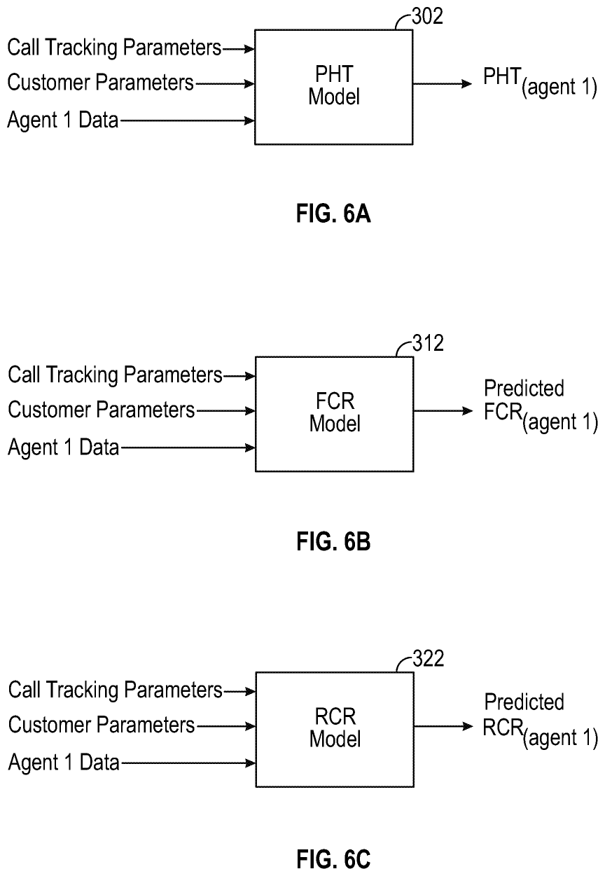

FIG. 6A is an illustrative functional block diagram representing the PHT model 302 of FIG. 4A used to produce an example predicted PHT for agent 1 for an example call. FIG. 6B is an illustrative functional block diagram representing the FCR model 312 of FIG. 4B used to produce an example predicted FCR for agent 1 for the example call. FIG. 6C is an illustrative functional block diagram representing the RCR model 322 of FIG. 4C used to produce an example predicted RCR for agent 1 for the example call.

Referring to the first row of the first table shown in FIG. 3A, for example, the PHT model 302 may be used to produce a predicted AHT for the first agent (agent 1) for the multiple test data calls handled by agent 1 as follows. A PHT is determined for each of the 1624 of the 100,000 ‘test data’ calls that involve agent 1. An Efficiency for agent 1 is determined based upon a sum of the 1624 PHT's divided by 1624. An efficiency of agent 1 is determined as,

(AHTAgent1−PHTAgent1)/PHTAgent1. (7)

It is noted that agent 1 has a negative efficiency value indicating that agent 1 is an ‘efficient’ agent.

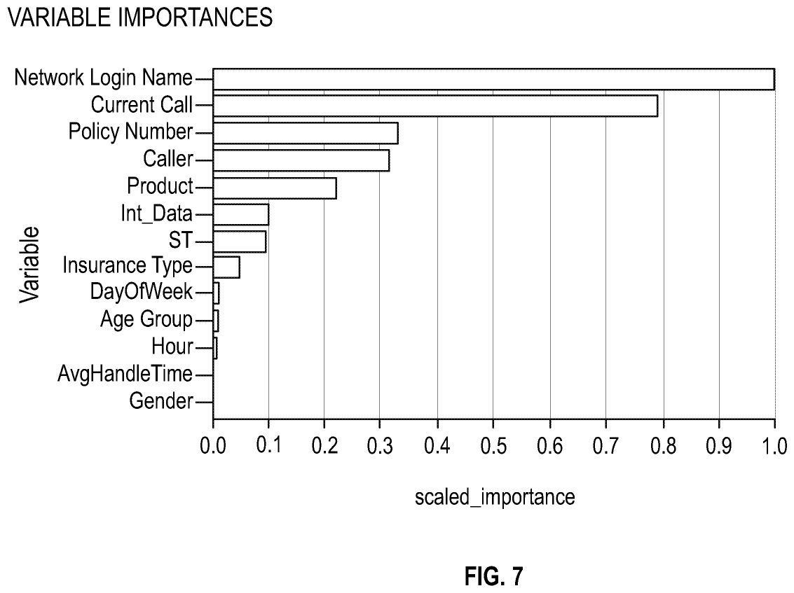

FIG. 7 is an illustrative second graph that prioritizes information variables according to their influence upon occurrence of repeat calls. The prioritization may be determined based upon training data, for example. Agent identity is again the most important variable, followed by whether the current call is a repeat call, policy, caller (whether the owner is calling or someone else on his/her behalf), product type, etc. Repeat calls can be reduced by routing the calls to appropriate agents. The other variables are not as significant to efficiency of call routing.

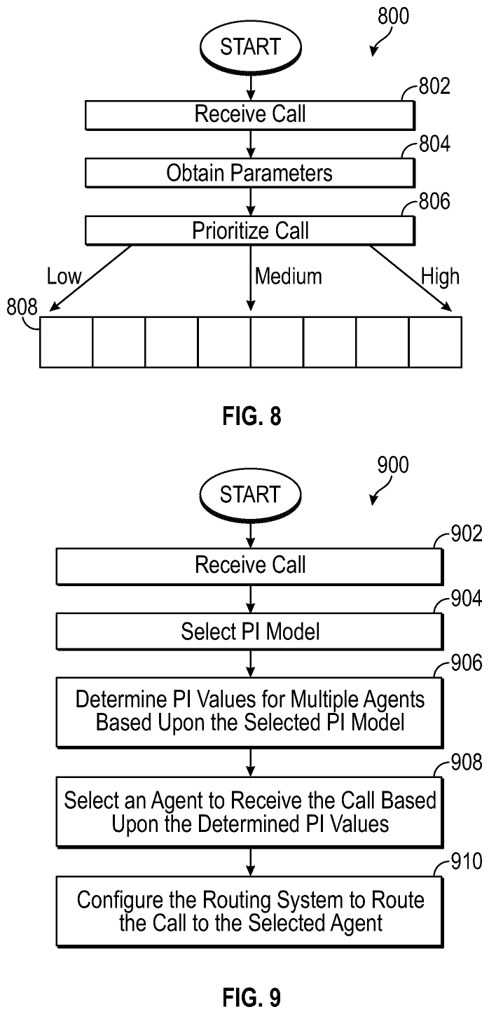

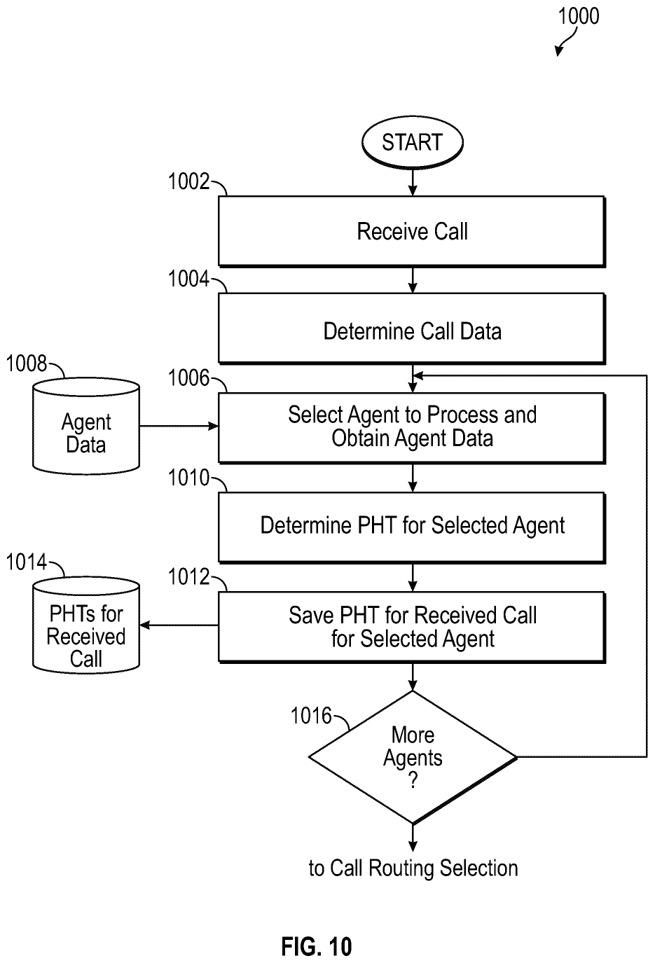

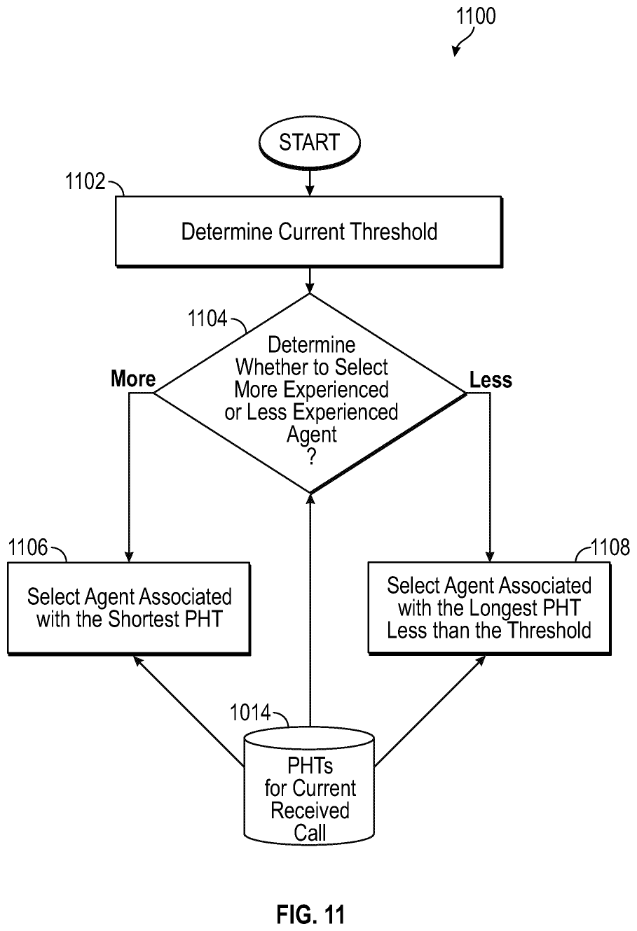

FIG. 8 is an illustrative functional block diagram of a call prioritization system 800 to prioritize calls in the queue 142 in accordance with some embodiments. The processor circuits 110 of the control system 102 may be specially configured according to the instructions 122 to implement the call prioritization system 800. At block 802 a call is received over the network I/O interface 106. Receipt of a call data may involve interactive voice and/or data communication with a caller over the communications network 150. At block 804, call data is obtained over the call UI 114, which as explained above, may include (IVR), dialed number identification service (DNIS), or chat features, for example. The call data may include call tracking data and customer data described above, for example. Block 806 determines a priority of the call based upon one or more parameters from the call data and places the call at a position in the queue circuit 142 based upon the determined call priority relative to determined priority of other calls. It will be appreciated that the queue 142 orders the processing of received calls, and from a perspective of the agent selection described below with reference to FIGS. 10-11, the current call may be a call that is at the head of the queue and that currently is next in line to be read from the queue 142 for distribution to an agent. Instructions 112 may configure the processor 110 to prioritize calls within the queue 142 based upon call data or information provided by a caller at the call UI 114. A call may be designated as high priority and placed nearer the head of the queue based upon the portfolio value of the customer, for example.

FIG. 9 is an illustrative functional block diagram of a process 900 to route a call to an agent in accordance with some embodiments. The processor circuit 110 may be specially configured according to instructions 122 to cause the routing system 140 to route the call according to the process 900. Block 902 receives a call provided at network I/O 106. Block 904 selects a model from among the PHT model 300, FCR model 310 and RCR model 320. An administrator may configure the block 904 to select the model based upon characteristics, such as source location of call, callerID, or time of day of the call, for example. Block 906 determines a PI value (e.g., PHT, FCR or RCR) for each of multiple agents available to receive the call based upon the selected model. Block 908 selects an agent to receive the call based upon the determined PI values for the multiple agents. Block 910 configures the routing system 140 to route the received call from the network I/O 106 to an agent device 104 via a call queue 142.

FIG. 10 is an illustrative functional block diagram of a process 1000 to determine individual agent PHTs for individual calls in accordance with some embodiments. The processor circuit 110 may be specially configured according to instructions 122 to determine PHTs for individual agents for individual calls according to the process 1000. Block 1002 receives a call provided at network I/O 106. Block 1004 determines call data that may be provided at the network interface I/O 106 or that may be provided via the call UI 114. Block 1006 selects a next agent to be processed. As explained above, contact center 100 typically employs many agents each associated with a different agent device 104. Block 1006 retrieves agent data for the currently selected agent from a storage device 1008 within memory storage 112. Block 1010 uses the PHT model 302 to determine a PHT value for the currently selected agent based upon the determined call data for the received call and the agent data for the currently selected agent. Block 1012 saves the determined PHT value for the currently selected agent for the received call within a storage device 1014 within the memory storage 112. Decision block 1016 determines whether there are additional agents to process for the received call. If yes, control flows back to block 1006 and a next agent is selected. If no, control flows to the agent selection system 1100 of FIG. 11.

FIG. 11 is an illustrative functional block diagram of an agent selection system 1100 to select an agent to handle a current call from among a set of agents having PHTs in accordance with some embodiments. If an incoming call is always routed to the most efficient agent available, there is a danger of more efficient agents being overloaded and the less efficient agents being underworked. So, there is a need for balancing the load across all the agents. It turns out many calls are of the simple type, i.e., the PHT is low for all agents compared to the overall average. Such calls can be routed to less efficient agents without loss to the overall efficiency. The processor circuit 110 may be specially configured according to instructions 122 to implement such an agent selection system 1100. Block determines a current threshold time length that may be used to classify a currently received call as long or short. In some embodiments, the threshold time length value is determined based upon,

Average Call Handling Time−1*Standard Deviation of current Call Handling Times (10)

Decision block 1104 determines whether to select a more experienced agent or a less experienced agent based upon whether a currently received call is classified as long or short. In accordance with some embodiments, a currently received call is classified as a long call if the shortest PHT within storage device 1014 associated with the currently received call is longer than the threshold value. In accordance with some embodiments, a currently received call is classified as a short call if the shortest PHT within storage device 1014 associated with the currently received call is shorter than the threshold value. In response to a determination to classify the call as a long call, block 1106 selects an agent associated with a shortest PHT within storage device 1014 for the currently received call. In response to a determination to classify the call as a short call, block 1108 selects an agent associated with the longest PHT that is within the threshold value.

### EXAMPLES

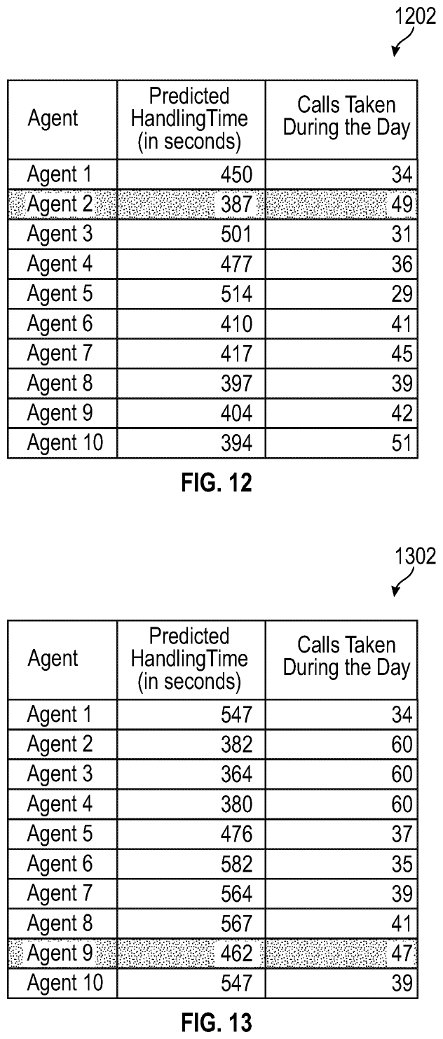

FIG. 12 is an illustrative example first prioritized agent chart 1202 identifying set of agents and associated PHTs corresponding to an example first received call in accordance with some embodiments. The PHTs in the second prioritized agents chart 1302 may be determined saved in storage device 1014 by the system 1000, represented in FIG. 10, which determines individual agent PHTs. The example first prioritized agents chart 1202 identifies ten different agents and associated PHTs determined for the first received call. The example first prioritized agent chart 1202 also indicates the number of calls that each of the 10 agents already has handled during that particular day. In this example, it is assumed that block 1102 has determined that a current threshold has a value less than 387 seconds. Agent 2 has a PHT of 387 seconds, which is the lowest PHT in the first prioritized agent chart 1202, and which is longer than the current threshold value. Thus, decision block 1104 classifies the first received call as a long call. Block 1106 selects an agent to handle the call who has the shortest PHT and who has not exceeded a 60 call per day limit. In this example, Agent 2 has the lowest PHT, 387 seconds, and has handled only 49 calls during the current day. Therefore, block 1106 selects Agent 2 to handle the example first received call. The processor 110 instructs the routing system 140 to route the first example call to an agent device 104 associated with Agent 2.

FIG. 13 is an illustrative example second prioritized agent chart 1302 identifying set of agents and associated PHTs corresponding to an example second received call in accordance with some embodiments. The PHTs in the second prioritized agents chart 1302 may be determined saved in storage device 1014 by the system 1000, represented in FIG. 10, which determines individual agent PHTs. The example second prioritized agent chart 1302 identifies ten different agents and associated PHTs determined for the second received call. The example second prioritized agent chart 1302 also indicates the number of calls that each of the 10 agents already has handled during that particular day. In this example, it is assumed that block 1102 has determined that a current threshold has a value less than 364 seconds. The lowest PHT in the second prioritized agents chart 1302 is 364 seconds. Therefore, decision block 1104 classifies the second example received call is a long call. The three Agents with the shortest PHTs in the second prioritized agent chart 1302, Agents 2, 3 and 4, already have reached the maximum limit of 60 calls per day, and therefore, are ineligible to handle the second example received call. Thus, block 1106 selects Agent 9, who is associated with the next lowest PHT, 462 seconds, and who has not exceeded the 60 call limit, to handle the call. The processor 110 instructs the routing system 140 to route the second example call to an agent device 104 associated with Agent 9.

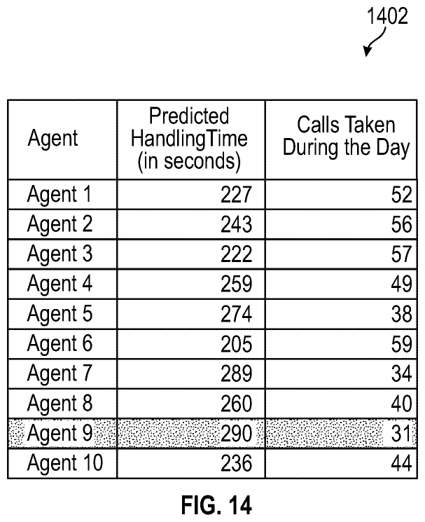

FIG. 14 is an illustrative example third prioritized agent chart 1402 identifying set of agents and associated PHTs corresponding to an example third received call accordance with some embodiments. The PHTs in the second prioritized agents chart 1302 may be determined saved in storage device 1014 by the system 1000, represented in FIG. 10, which determines individual agent PHTs. The example third prioritized agent chart 1402 identifies ten different agents and associated PHTs determined for the third received call. The example third prioritized agent chart 1402 also indicates the number of calls that each of the 10 agents already has handled during that particular day. In this example, it is assumed that block 1102 has determined that a current threshold has a value greater than 222 seconds and less than 290 seconds. The lowest PHT in the second prioritized agents chart 1302 is 222 seconds. Therefore, decision block 1104 classifies the third example received call as a short call. None of the Agents listed in the third prioritized agent chart 1402 has exceeded the 60 call daily limit, and therefore, all ten agents are eligible to handle the call. In accordance with some embodiments, block 1106 selects Agent 9 to handle the call since the Agent 9 PHT, 290 seconds, is the longest PHT in the third prioritized agent chart 1402 that is within (less than or equal to) the currently determined threshold value. So, instead of routing the third example call to the agent (Agent 6) with the lowest predicted PHT of 205 seconds, the third example call is routed to an agent with a longest predicted PHT within the current acceptable handling-time length (e.g., within a standard deviation of the current average call handling time) and a relatively low number of calls handled for the current day, who happens to be Agent 9 with a predicted handling time of 290 seconds and 31 calls already handled for the day. This selection ensures that some agents (e.g., newer, less efficient agents) are not starved for work and others (e.g., more efficient agents) are not overworked. The processor 110 instructs the routing system 140 to route the third example call to an agent device 104 associated with Agent 9.

The above description is presented to enable any person skilled in the art to create and use a system and method to route calls to agents. Various modifications to the embodiments will be readily apparent to those skilled in the art, and the generic principles defined herein may be applied to other embodiments and applications without departing from the spirit and scope of the invention. In the preceding description, numerous details are set forth for the purpose of explanation. However, one of ordinary skill in the art will realize that the embodiments in the disclosure might be practiced without the use of these specific details. In other instances, well-known processes are shown in block diagram form in order not to obscure the description of the invention with unnecessary detail. Identical reference numerals may be used to represent different views of the same or similar item in different drawings. Thus, the foregoing description and drawings of embodiments in accordance with the present invention are merely illustrative of the principles of the invention. Therefore, it will be understood that various modifications can be made to the embodiments by those skilled in the art without departing from the spirit and scope of the invention, which is defined in the appended claims.

1. A system configured to control routing of incoming customer calls to agent devices over a routing system, comprising:
a processor and a non-transitory computer readable medium operably coupled thereto, the non-transitory computer readable medium comprising a plurality of instructions stored in association therewith that are accessible to, and executable by, the processor, where the plurality of instructions comprises:
instructions that, when executed, determine respective performance indicators (PIs) to associate with respective agents in response to a received call; and
instructions that, when executed, select a respective agent to handle the received call at least based in part upon the determined respective PIs.

2. The system of claim 1 further including:
instructions that, when executed, cause the routing system to route the received call to the respective agent device associated with the respective selected respective agent.

3. The system of claim 1 further including:
a network interface to receive an incoming customer call; and
instructions that, when executed, cause the routing system to route the received call to the respective agent device associated with the respective selected respective agent.

4. The system of claim 1,
wherein the instructions that, when executed, determine respective PIs, determine respective predicted handling times to associate with respective agents in response to a received call.

5. The system of claim 1,
wherein the instructions that, when executed, determine respective PIs, determine respective first call resolution rates to associate with respective agents in response to a received call.

6. The system of claim 1,
wherein the instructions that, when executed, determine respective PIs, determine respective repeat call rates to associate with respective agents in response to a received call.

7. A system configured to control routing of incoming customer calls to agent devices over a routing system, comprising:
a processor and a non-transitory computer readable medium operably coupled thereto, the non-transitory computer readable medium comprising a plurality of instructions stored in association therewith that are accessible to, and executable by, the processor, where the plurality of instructions comprises:
instructions that, when executed, determine respective predicted handling times (PHTs) to associate with respective agents in response to a received call; and
instructions that, when executed, select a respective agent to handle the received call at least based in part upon the determined respective PHTs.

8. The system of claim 7 further including:
wherein the instructions that, when executed, determine respective PHTs to associate with respective agents in response to a received call, determine based at least in part upon information indicative of likely call duration and information indicative of agent call-handling skills.

9. The system of claim 7 further including:
instructions that, when executed, determine a threshold time length;
wherein the instructions to select, when executed, select based at least in part based upon the determined threshold time length.

10. The system of claim 7 further including:
instructions that, when executed, determine a threshold time length;
instructions to determine whether at least one PHT is shorter than the determined threshold time length;
wherein the instructions to select, select an agent associated with a PHT within the determined threshold time length in response to a determination that at least one respective determined PHT is shorter than the determined threshold time length.

11. The system of claim 7 further including:
instructions that, when executed, determine a threshold time length;
instructions to determine whether at least one PHT is shorter than the determined threshold time length;
wherein the instructions to select, select an agent associated with a longest PHT within the determined threshold time length in response to a determination that at least one respective determined PHT is shorter than the determined threshold time length.

12. The system of claim 7 further including:
instructions that, when executed, determine a threshold time length;
instructions to determine whether at least one PHT is shorter than the determined threshold time length; and
wherein the instructions to select, select an agent associated with a shortest PHT longer than the determined threshold time length in response to a determination that no PHT is longer than the determined threshold time length.

13. The system of claim 7 further including:
instructions that, when executed, determine a threshold time length;
instructions to determine whether at least one PHT is shorter than the determined threshold time length;
wherein the instructions to select, select an agent associated with a PHT longer than the determined threshold time length in response to a determination that no PHT is longer than the determined threshold time length; and
wherein the instructions to select, select an agent associated with a PHT within the determined threshold time length in response to a determination that at least one respective determined PHT is shorter than the determined threshold time length.

14. The system of claim 7 further including:
instructions that, when executed, determine a threshold time length;
instructions to determine whether at least one PHT is shorter than the determined threshold time length;
wherein the instructions to select, select an agent associated with a shortest PHT longer than the determined threshold time length in response to a determination that no PHT is longer than the determined threshold time length; and
wherein the instructions to select, select an agent associated with a shortest PHT longer than the determined threshold time length in response to a determination that no PHT is longer than the determined threshold time length.

15. The system of claim 1 further including:
instructions that, when executed, determine priority of the received call within a call queue.

16. The system of claim 1 further including:
instructions that, when executed, determine priority of the received call within a call queue based upon caller information provided to a caller user interface.

17. The system of claim 1 further including:
instructions that, when executed, remove an agent from eligibility to handle a call after a prescribed maximum number of calls have been handled by the agent.

18. A system configured to control routing of incoming customer calls to agent devices over a routing system, comprising:
a processor and a non-transitory computer readable medium operably coupled thereto, the non-transitory computer readable medium comprising a plurality of instructions stored in association therewith that are accessible to, and executable by, the processor, where the plurality of instructions comprises:
instructions that, when executed, determine for each respective received call in the sequence, respective performance indicators (PIs) to associate with respective agents;
instructions that, when executed, select for each respective received call in the sequence, a respective agent to handle the respective received call at least based in part upon the respective PIs determined for the respective received call.

19. The system of claim 18 further including:
instructions that, when executed, cause the routing system for each respective received call in the sequence, to route the received call to the respective agent device associated with the respective agent selected for the received call.

20. The system of claim 18 further including:
a network interface to receive a sequence of respective calls; and
instructions that, when executed, cause the routing system for each respective received call in the sequence, to route the received call to the respective agent device associated with the respective agent selected for the received call.

21. A method to control routing of incoming customer calls to agent devices over a routing system comprising:
receiving a customer call;
determining respective performance indicators (PIs) to associate with respective agents in response to the received call;
selecting a respective agent to handle the received call at least based in part upon the determined respective PIs; and
routing the received call over a call routing system to a respective agent device associated with the respective selected respective agent.

22. The method of claim 21 further including:
wherein determining multiple respective PIs includes determining the multiple respective predicted handling times (PHTs) based at least in part upon information indicative of likely call duration and information indicative of agent call-handling skills.

23. The method of claim 21 further including:
determining a threshold time length; and
selecting based at least in part based upon the determined threshold time length.

24. The method of claim 21,
wherein the PI includes a predicted handling time (PHT); further including:
determining a threshold time length;
determining whether at least one PHT is shorter than the determined threshold time length;
selecting an agent associated with a PHT longer than the determined threshold time length in response to a determination that no PHT is longer than the determined threshold time length; and
selecting an agent associated with a PHT within the determined threshold time length in response to a determination that at least one respective determined PHT is shorter than the determined threshold time length.

25. The method of claim 21,
wherein the PI includes a predicted handling time (PHT); further including:
determining a threshold time length;
determining whether at least one PHT is shorter than the determined threshold time length;
selecting an agent associated with a shortest PHT longer than the determined threshold time length in response to a determination that no PHT is longer than the determined threshold time length; and
selecting an agent associated with a shortest PHT longer than the determined threshold time length in response to a determination that no PHT is longer than the determined threshold time length.

26. A non-transitory machine-readable storage medium including instructions that, when executed by a machine, cause the machine to perform operations comprising:
determining respective performance indicators (PIs) to associate with respective agents in response to the received call; and
selecting a respective agent to handle the received call at least based in part upon the determined respective PIs.

27. The non-transitory machine-readable storage medium of claim 26 further including:
causing the routing system to route the received call to the respective agent device associated with the respective selected respective agent.

28. The non-transitory machine-readable storage medium of claim 22,
wherein the PI includes a predicted handling time (PHT); further including:
determining a threshold time length;
determining whether at least one PHT is shorter than the determined threshold time length;
selecting an agent associated with a shortest PHT longer than the determined threshold time length in response to a determination that no PHT is longer than the determined threshold time length; and
selecting an agent associated with a shortest PHT longer than the determined threshold time length in response to a determination that no PHT is longer than the determined threshold time length.
